(19) United States
(12) Patent Application Publication
(10) Pub. No.: US 2008/0303258 A1
(43) Pub. Date: Dec. 11, 2008

(54) MOTORCYCLE SWING-PREVENTING DEVICE

(76) Inventor: Shen-Yuan KUO, Kuan-Miao Hsiang (TW)

Correspondence Address: Shen-Yuan KUO, P. O. BOX 90, Tainan City, 70499, TW

(21) Appl. No.: 11/758,005

(22) Filed: Jun. 5, 2007

(51) Int. Cl. B62K 11/14

(52) U.S. Cl. 280/755

(57) ABSTRACT

A motorcycle swing-preventing device includes a fixing base mounted on the steering shaft of a motorcycle head. A connecting member has its universal bearing pivotally combined with the fixing base. A swing preventer is disposed with a connecting base having a universal bearing secured with the connecting member. A positioning base is fixed on the motorcycle head, and the damping rod of the swing preventer has one end pivotally combined with the positioning base. Thus, the universal bearing on the connecting base is kept immovable and the swing preventer has its fulcrum shifted to the universal bearing of the connecting member for shortening its swing stroke. The swing preventer can also have its fixing base extending outward properly to form a connecting base with a universal bearing pivotally combined with the fixing base.

### BACKGROUND OF THE INVENTION

1. Field of the Invention

This invention relates to a motorcycle swing-preventing device, particularly to one provided with a small-stroke swing preventer able to match with large steering angle of a motorcycle head and applicable to be assembled at a location distant from the steering shaft of the motorcycle head for preventing the motorcycle head from swinging violently, able to elevate safety in motorcycle riding.

2. Description of the Prior Art

As commonly known, the front fork rod of the front wheel of a motorcycle is turned by the handgrip and controlled by the steering shaft of the motorcycle head. Generally, when a motorcycle runs at high speeds or makes a turn excessively on an uneven and slippery road surface, the front wheel of the motorcycle will rise from the ground or lower its ground-holding force, and when the front wheel touches the ground again, due to different rotating speeds of the wheel and variation of the ground-holding force, and the motorcycle head will swing too violently to be controlled steadily by the rider, producing a so-called motorcycle head-swinging phenomenon. For preventing the motorcycle head from swinging violently when the motorcycle runs at high speeds, a swing preventer can be additionally disposed on the motorcycle head for producing a damping force to the motorcycle head by means of the oil pressure resistance of the swing preventer so as to lower the swinging extent of the motorcycle head, and keep steady and ensure safety in motorcycle riding.

For the present, a conventional motorcycle swing preventer is only to be assembled on a straddle-type heavy motorcycle, as shown in FIG. 1, because the instrument panel 10 on the head 1 of a straddle-type heavy motorcycle is assembled in front of a steering device and therefore, the space at the front of the oil tank 12 and above the steering device 11 is large enough for installing the swing preventer 13 without interfering other devices. The steering device 11 is provided with two wheel fork rods 110 and a steering shaft 111 for actuating the motorcycle head 1 to turn in different directions. The conventional swing preventer 13, as shown in FIG. 2, is provided with a casing 130 having the exterior of its intermediate portion secured with a fixing base 131 having one side fixed with a connecting base 132 fitted thereon with a universal bearing 133 to be pivotally combined with the motorcycle frame 14. A damping rod 134 is inserted in the casing 130 of the swing preventer 13 and has one end fitted with a universal bearing 135 to be pivotally assembled with a positioning plate 15 that is secured on the steering device 11. The casing 130 of the swing preventer 13 is further provided with a pressure-regulating button 136 for controlling the oil pressure resistance of the swing preventer 13 in accordance with the damping force needed for different road surfaces. Thus, with the damping action produced by the swing preventer 13, the motorcycle running on an uneven road surface at high speed can absorb a violent swing force produced by the steering device 11 and avoid swinging of the motorcycle head.

However, the conventional swing preventer 13 is inapplicable to a scooter because the scooter head 16 is provided with an instrument panel 160 and has its outer side covered with a shell 161, and it is impossible to directly assemble the swing preventer 13 on the steering shaft 162 of the scooter head 16. If the swing preventer 13 is to be assembled inside the shell 161, it will be impossible to handle the pressure-regulating button 136 of the swing preventer 13 for controlling the oil pressure resistance inside the swing preventer 13 according to different road surfaces on which the scooter runs, and additionally the steering angle (B) of the scooter head 16 of is larger than that of the head 1 of a heavy motorcycle. Therefore, if the swing preventer 13 is to be installed on the scooter head 16, a fixing plate 163 for fixing the swing preventer 13 has to be extended outward to a distance (A) comparatively far away from the steering shaft 162 to dodge the scooter shell 161, letting the swing preventer positioned out of the scooter shell 161 for facilitating operation, as shown in FIGS. 3 and 4. On the other hand, in case of maintaining the originally designed steering angle (B) of the scooter head 16, it is necessary to assemble a swing preventer 13 with a comparatively long stroke (C). However, the longer the stroke (C) is, the larger the size of the swing preventer 13 will be and the higher the cost of the swing preventer 13 will become, and further the opposite ends of the swing preventer 13 with a comparatively long stroke (C) will respectively extend out of the scooter body, thus, affecting the external beauty of the scooter. Therefore, a scooter seldom has its head 16 provided thereon with the swing preventer 13; Nevertheless, when a scooter runs on an uneven road surface at high speed, dangerous situation of swinging of the scooter head 16 still will happen and therefore, this shortcoming has to be improved.

### SUMMARY OF THE INVENTION

The objective of this invention is to offer a motorcycle swing-preventing device provided with a small-stroke swing preventer able to tally with a comparatively large steering angle of a motorcycle head and applicable to be assembled at a location distant from the steering shaft of the motorcycle head for preventing the motorcycle head from swinging violently and for insuring safety in motorcycle riding.

A first feature of the motorcycle swing-preventing device in the present invention is a motorcycle head provided with a steering shaft having its topside fitted with a handgrip and its upper end secured with a fixing base with an insert hole. The motorcycle head further has a motorcycle frame provided in the interior of its shell. A connecting member to be pivotally assembled on the fixing base of the steering shaft is disposed with a universal bearing inserted therein with a pivot member, and a positioning base is secured on the motorcycle frame. A swing preventer to be combined with both the connecting member and the positioning base is provided with a casing having a fixing base secured on the intermediate exterior. The fixing base of the swing preventer has one side formed with a connecting base fitted thereon with a universal bearing to be secured with the connecting member. A damping rod is inserted in the casing of the swing preventer, having one end provided with a universal bearing inserted therein with a pivot member. The casing is further assembled thereon with a pressure-regulating button. The universal bearing on the connecting base of the swing preventer is immovably secured with the connecting member, impossible to be turned, and thus the fulcrum of the swing preventer can be shifted outward to the universal bearing of the connecting member so as to shorten the distance between the fulcrum of the swing prevneter and the steering shaft of the motorcycle head and thus shorten the swing stroke of the swing preventer, able to diminish the size of the swing preventer and enabling the small-stroke swing preventer to tally with the comparatively large steering angle of a motorcycle head.

A second feature of the motorcycle swing-preventing device in the present invention is a motorcycle head provided with a steering shaft having its topside mounted with a handgrip and its upper end secured with a fixing base with an insert hole, with a motorcycle frame positioned in the interior of the shell of the motorcycle head and a positioning base fixed on the motorcycle frame. A swing preventer to be pivotally combined with the fixing base of the steering shaft and the positioning base is disposed with a casing having a fixing base secured on the intermediate exterior. The fixing base of the swing preventer has one side extending outward for a proper length and formed with a connecting base, and the connecting base fitted thereon with a universal bearing having a pivot member inserted therein. A damping rod is inserted in the casing of the swing preventer, having one end set with a universal bearing having a pivot member inserted therein. The casing of the swing preventer is further disposed with a pressure-regulating button. Thus, by having one side of the fixing base of the swing preventer extending outward to a proper length and formed with the connecting base and having the universal bearing on the connecting base pivotally combined with the fixing base of the steering shaft, the fulcrum of the swing preventer is shifted to a location closer to the steering shaft so as to shorten the distance between the fulcrum of the swing preventer and the steering shaft and accordingly shorten the swing stroke of the swing preventer, thus reducing the size of the swing preventer and enabling the swing preventer with a comparatively small stroke to tally with the comparatively large steering angle of a motorcycle head.

### BRIEF DESCRIPTION OF DRAWINGS

This invention will be better understood by referring to the accompanying drawings, wherein:

FIG. 1 is an upper view of a conventional swing preventer assembled on a straddle-type heavy motorcycle;

FIG. 2 is a perspective view of the conventional swing preventer;

FIG. 3 is an upper view of the conventional swing preventer assembled on the head of a scooter;

FIG. 4 is an upper view of the conventional swing preventer swinging leftward and rightward;

FIG. 5 is an exploded perspective view of a first preferred embodiment of a motorcycle swing-preventing device in the present invention;

FIG. 6 is a perspective view of the first preferred embodiment of the motorcycle swing-preventing device in the present invention;

FIG. 7 is a side cross-sectional view of the first preferred embodiment of the motorcycle swing-preventing device in the present invention;

FIG. 8 is an upper view of the first preferred embodiment of the motorcycle swing-preventing device in a non-swing condition in the present invention;

FIG. 9 is an upper view of the first preferred embodiment of the motorcycle swing-preventing device swinging leftward and rightward for a stroke in the present invention;

FIG. 10 is an upper view of the first preferred embodiment of the motorcycle swing-preventing device in the present invention, showing that the head of a motorcycle is not turned;

FIG. 11 is an upper view of the first preferred embodiment of the motorcycle swing-preventing device in the present invention, showing that the head of the motorcycle is turned leftward;

FIG. 12 is an upper view of the first preferred embodiment of the motorcycle swing-preventing device in the present invention, showing that the motorcycle head is turned rightward;

FIG. 13 is an exploded perspective view of a second preferred embodiment of a motorcycle swing-preventing device in the present invention;

FIG. 14 is a perspective view of the second preferred embodiment of a swing preventer in the present invention;

FIG. 15 is a perspective view of the second preferred embodiment of the motorcycle sing-preventing device assembled on a motorcycle in the present invention;

FIG. 16 is a side cross-sectional view of the second preferred embodiment of the motorcycle swing-preventing device assembled on the motorcycle in the present invention;

FIG. 17 is an upper view of the second preferred embodiment of the motorcycle swing-preventing device in a non-swing condition in the present invention;

FIG. 18 is an upper view of the second preferred embodiment of the motorcycle swing-preventing device swinging leftward and rightward for a stroke in the present invention;

FIG. 19 is an upper view of the second preferred embodiment of the motorcycle swing-preventing device in the present invention, showing that the motorcycle head is not turned;

FIG. 20 is an upper view of the second preferred embodiment of the motorcycle swing-preventing device in the present invention, showing that the motorcycle head is turned leftward; and

FIG. 21 is an upper view of the second preferred embodiment of the motorcycle swing-preventing device in the present invention, showing that the motorcycle head is turned rightward.

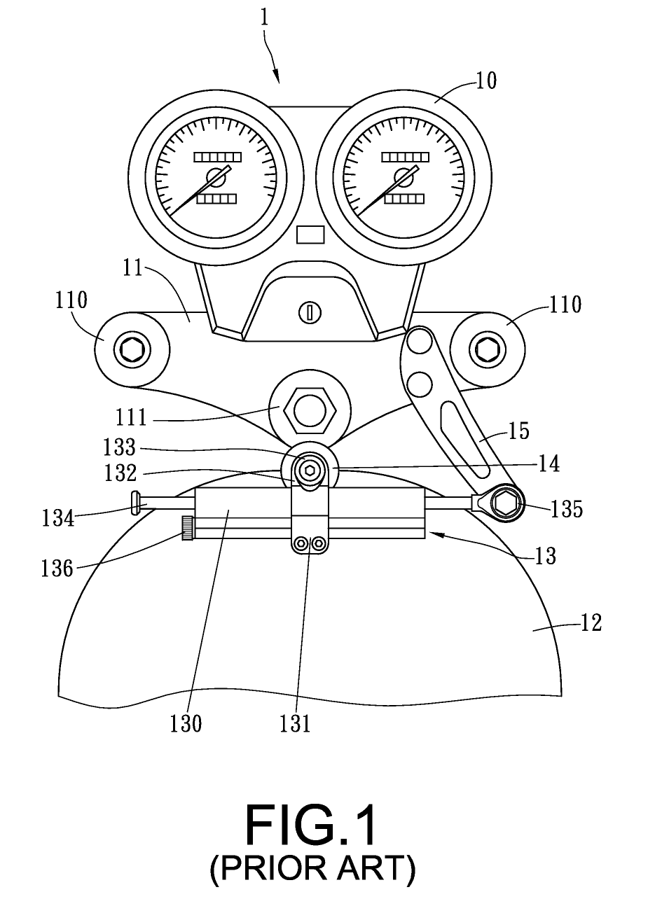

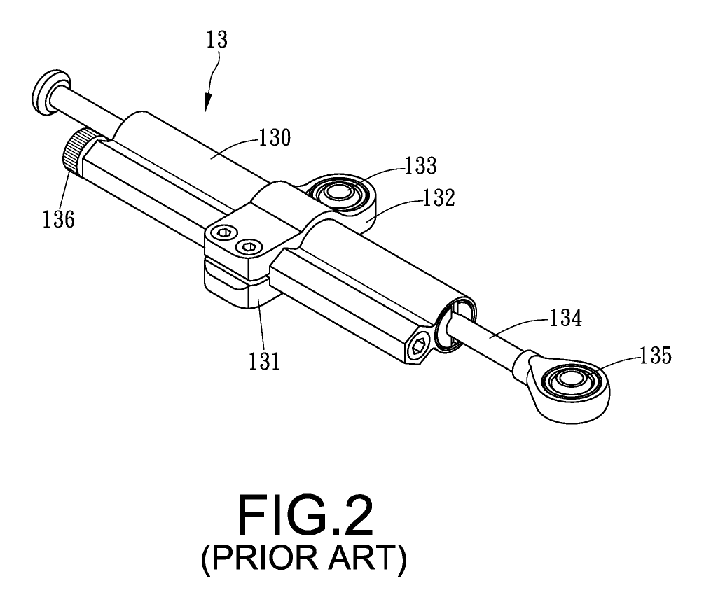

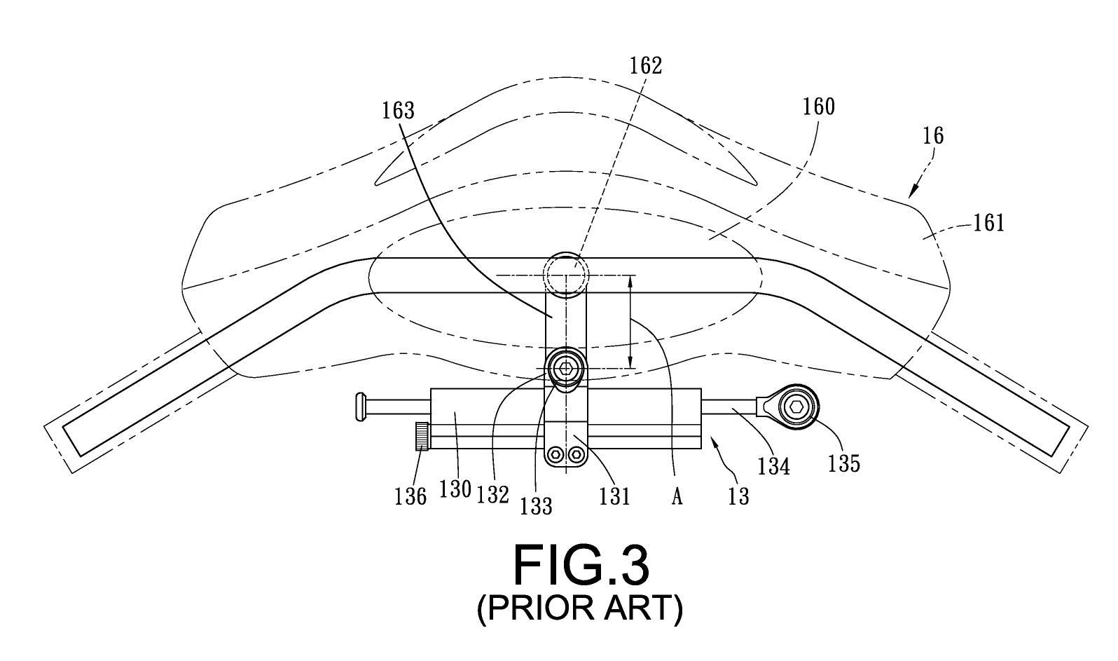

### DETAILED DESCRIPTION OF THE PREFERRED EMBODIMENT

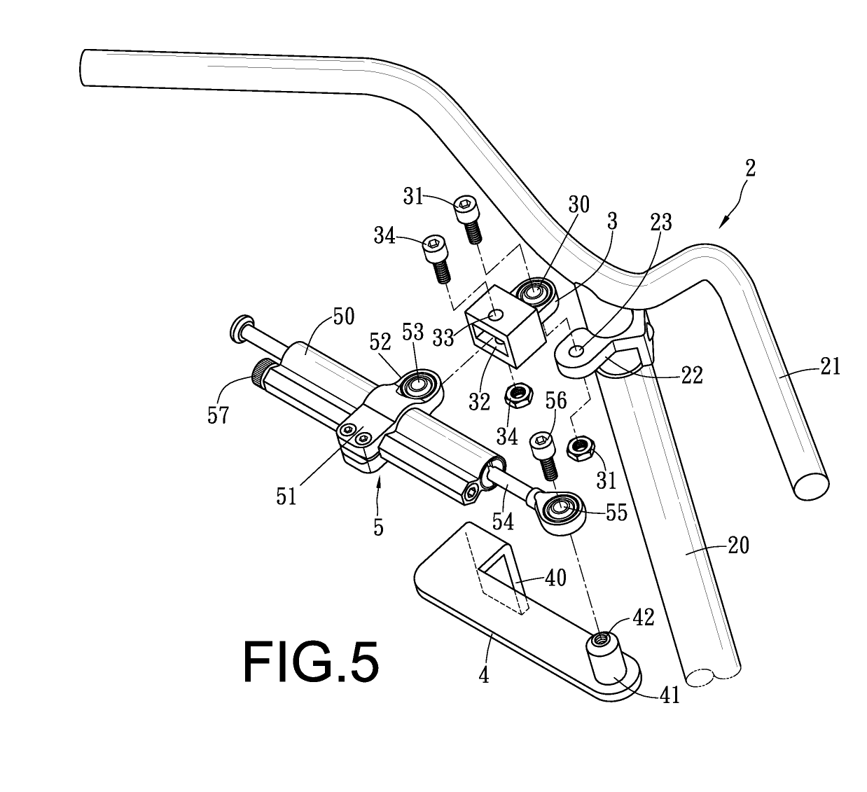

A first preferred embodiment of a motorcycle swing-preventing device in the present invention, as shown in FIGS. 5, 6 and 7, includes a motorcycle head 2, a connecting member 3, a positioning base 4 and a swing preventer 5 combined together.

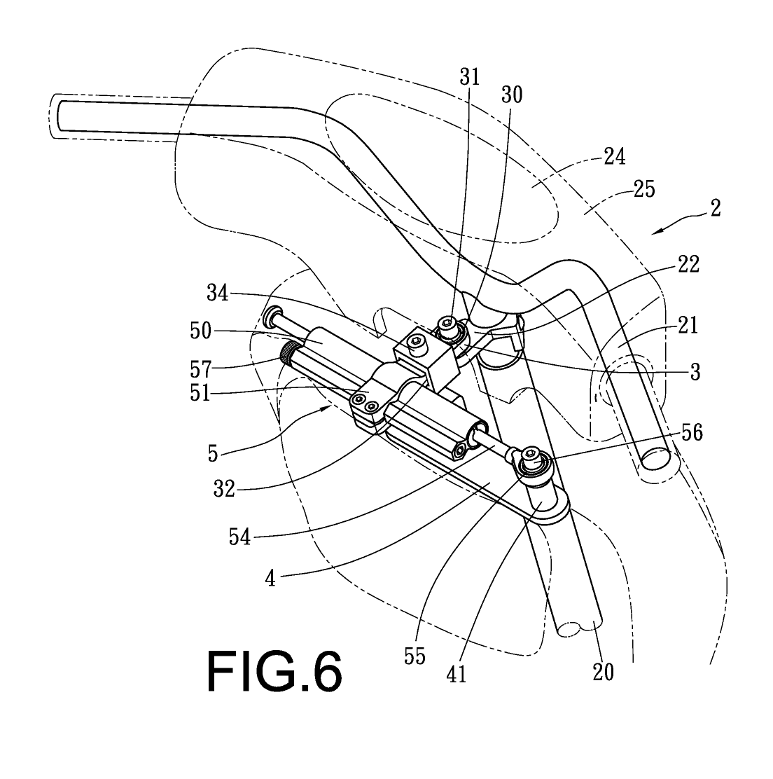

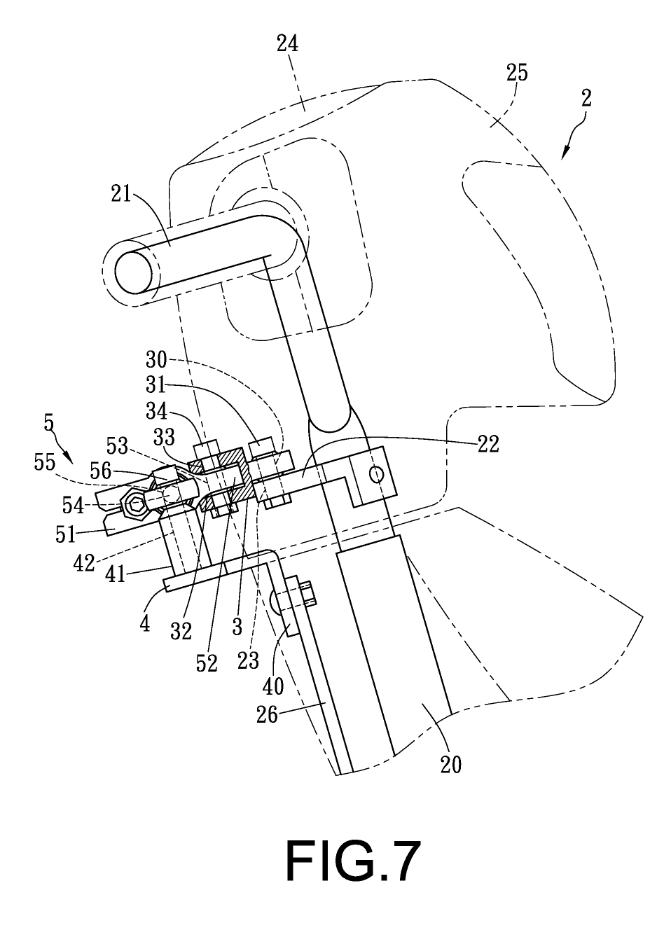

The motorcycle head 2 is provided with a steering shaft 20 having its topside mounted with a handgrip 21 and its upper end secured with a fixing base 22 with an insert hole 23. The motorcycle head 2 has its topside disposed with an instrument panel 24, as shown in FIG. 6, and its exterior covered with a shell 25, in which a motorcycle frame 26 is installed, as shown in FIG. 7.

The connecting member 3 to be pivotally assembled on the fixing base 22 of the steering shaft 20 is provided thereon with a universal bearing 30 having a pivot member 31 inserted therein. The connecting member 3 has one lateral side cut with an insert recess 32 and its topside bored with an insert hole 33 communicating with the insert recess 32 for a fastener 34 to be inserted therein.

The positioning base 4 to be fixed on the frame 26 has one end bent vertically and formed with a positioning plate 40 and the other end secured thereon with a stud 41 with a threaded hole 42.

The swing preventer 5 to be combined with both the connecting member 3 and the positioning base 4 is provided with a casing 50 having its intermediate exterior secured thereon with a fixing base 51 having one side set with a connecting base 52 fitted thereon with a universal bearing 53. A damping rod 54 is inserted in the interior of the casing 50, having one end provided with a universal bearing 55 inserted therein with a pivot member 56. The casing 50 is further provided with a pressure-regulating button 57.

In assembling, as shown in FIGS. 5, 6 and 7, firstly, the positioning plate 40 of the positioning base 4 is secured on the frame 26, and the connecting base 52 of the swing preventer 5 is inserted in the insert recess 32 of the connecting member 3, letting the universal bearing 53 aligned to the insert hole 33 of the connecting member 3. Then, the fastener 34 is inserted through both the universal bearing 53 and the insert hole 33 of the connecting member 3 for stably fixing the universal bearing 53 in the insert recess 32 of the connecting member 3, letting the universal bearing 53 lose potency and impossible to turn around. Next, the universal bearing 30 of the connecting member 3 is aligned to the insert hole 23 of the fixing base 22 on the steering shaft 20 and then the pivot member 31 is inserted through both the universal bearing 30 and the insert hole 23 for pivotally assembling the connecting member 3 on the fixing base 22. Subsequently, the universal bearing 55 at one end of the damping rod 54 is aligned to and positioned on the stud 41 of the positioning base 4, and the pivot member 56 is inserted through the universal bearing 55 and screwed with the threaded hole 42 of the stud 41, letting one end of the damping rod 54 pivotally positioned on the positioning base 4. At this time, the swing preventer 5 is positioned at the outer side of the motorcycle shell 25 so that a motorcycle rider can conveniently regulate the pressure-regulating button 57 for controlling the oil pressure resistance in the swing preventer 5, thus, finishing assembly of the motorcycle swing-preventing device.

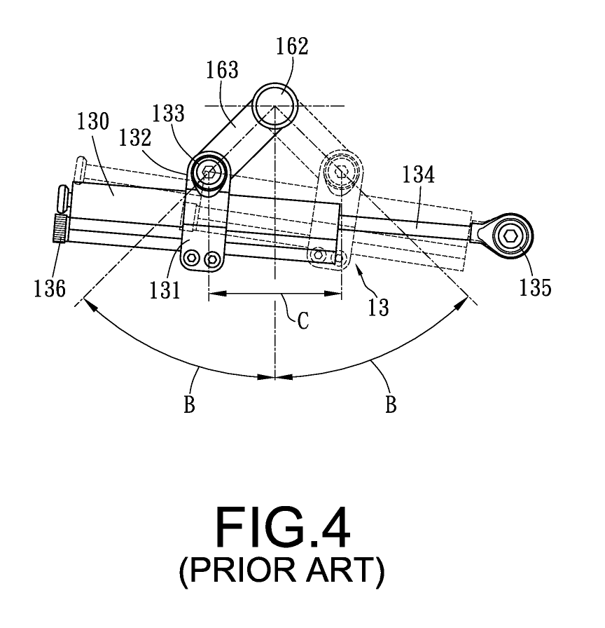

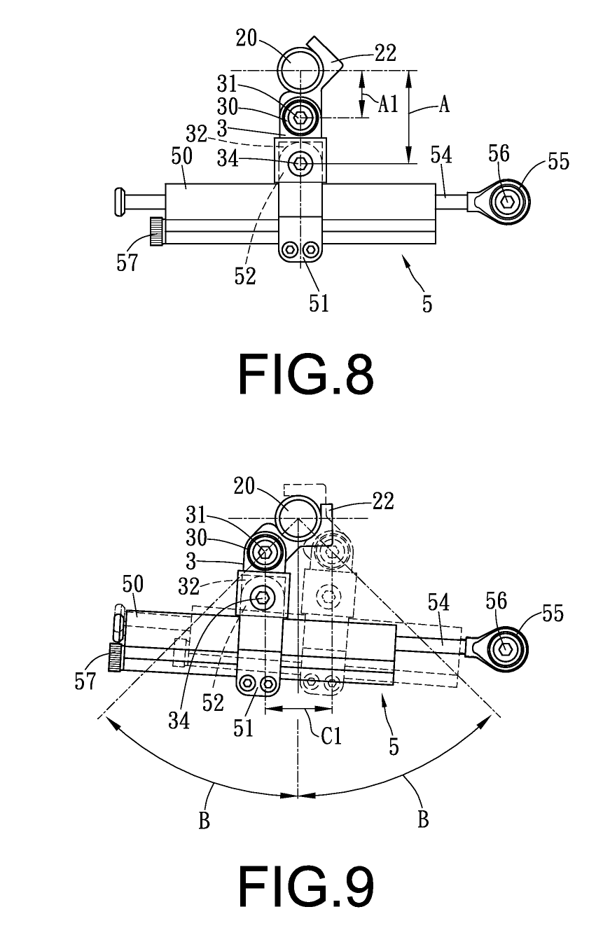

Specifically, the motorcycle swing-preventing device of this invention makes use of an originally designed swing preventer 5 without changing its structure. Referring to FIGS. 6, 8 and 9, the swing preventer 5 is connected to the fixing base 22 of the motorcycle head 2 by means of the connecting member 3 and has the universal bearing 53 on its connecting base 52 secured in the insert recess 32 and immovably combined together with the connecting member 3, letting the universal bearing 53 impossible to be turned around. Further, the connecting member 3 is provided thereon with the universal bearing 30, which takes the place of the original universal bearing 53 of the originally designed swing preventer 5 to serve as a fulcrum of the swing preventer 5; in other words, the location of fulcrum of the swing preventer 5 is shifted to the universal bearing 30 of the connecting member 3. By so designing, the location of the fulcrum of the swing preventer 5 can be changed by means of the connecting member 3 for shortening the distance (A1) between the fulcrum (the universal bearing 30) of the swing preventer 5 and the steering shaft 20 of the motorcycle head 2 as well as for shortening the swing stroke (C1) of the swing preventer 5, referring to the stroke (C) in FIG. 4 and the stroke (C1) in FIG. 9. Thus, the swing preventer 5 with a comparatively small stroke (C1) in this invention can attain a comparatively large steering angle (B), and the stroke (C1) of the swing preventer 5 of this invention is shorter than the stroke (C) of the conventional swing preventer 13 by ⅓ to ½. Therefore, the swing preventer 5 of this invention can be greatly diminished in size and its opposite ends will not extend out of the opposite sides of the motorcycle body, able to lower cost of the swing preventer 5. In addition, the swing preventer 5 is positioned at the exterior of the motorcycle shell 25, so it is convenient to regulate the pressure-regulating button 57 of the swing preventer 5 anytime for controlling the oil pressure resistance inside the swing preventer 5 in accordance with the conditions of the road surface, able to attain excellent effect in preventing the motorcycle head from swinging. Moreover, assembling the swing preventer 5 at the outer side of the motorcycle shell 25 will facilitate regulating of the damping force, and it may look cool and fashionable to additionally assemble such a swing preventer 5, giving the feeling of the value of the motorcycle elevated.

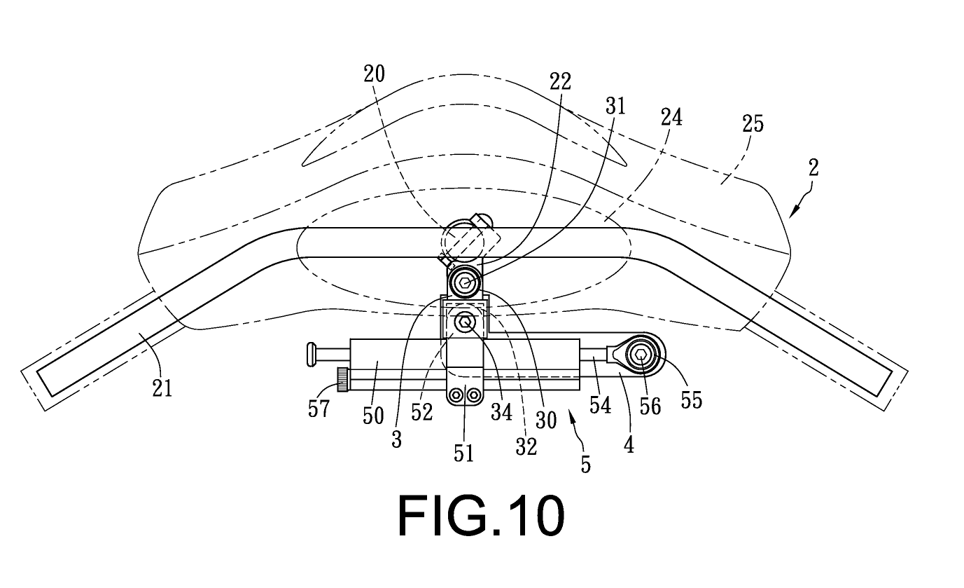

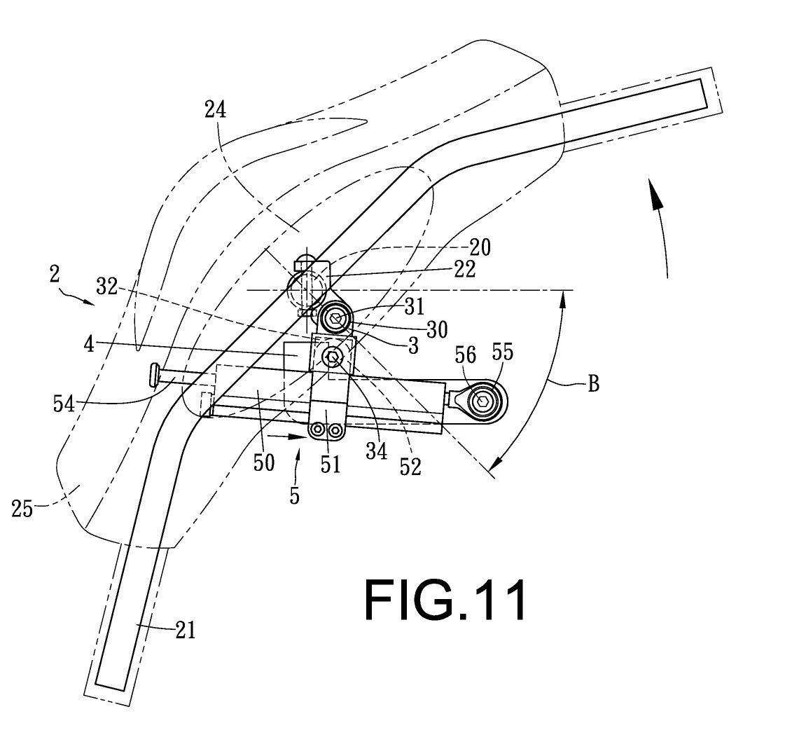

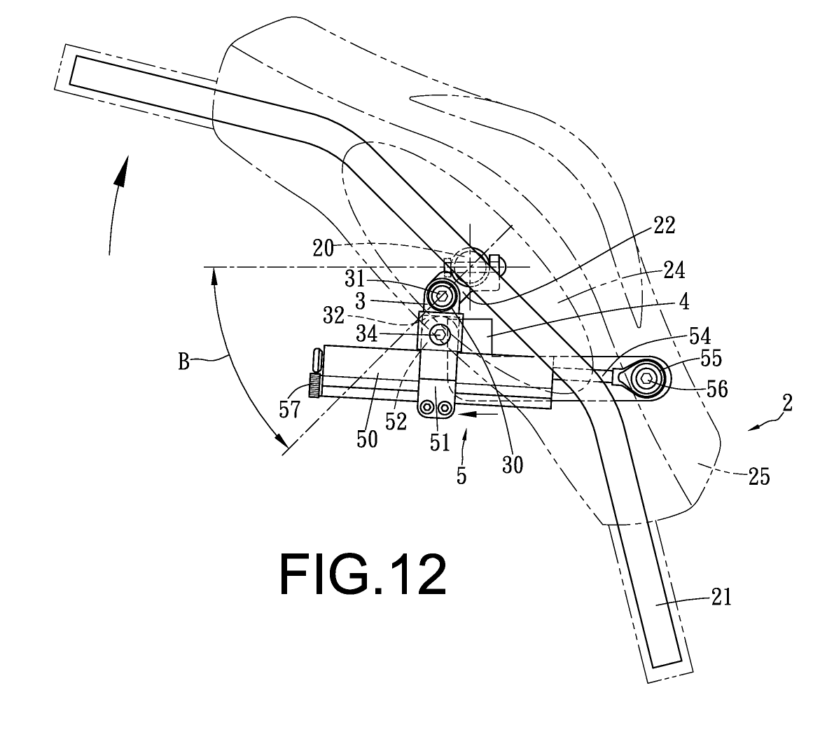

In using, when the handgrip 21 of the motorcycle head 2 is turned leftward, as shown in FIGS. 10 and 11, the steering shaft 20 will drive the fixing base 22 to turn counterclockwise and actuate the connecting member 3 to move rightward. Since the damping rod 54 inside the casing 50 of the swing preventer 5 has the universal bearing 55 at one end pivotally fixed on the positioning base 4; therefore, when the fixing base 22 is turned counterclockwise, the connecting member 3 will actuate the casing 50 of the swing preventer 5 to slide and move rightward along the damping rod 54, but the damping rod 54 will be kept immovable. Thus, when turned leftward, the motorcycle head 2 can be prevented from swinging by means of the oil pressure resistance in the swing preventer 5. On the contrary, when the handgrip 21 of the motorcycle head 2 is turned rightward, as shown in FIG. 12, the steering shaft 20 will drive the fixing base 22 to turn clockwise and actuate the connecting member 3 to move leftward, and simultaneously the connecting member 3 will actuate the casing 50 of the swing preventer 5 to slide and move leftward along the damping rod 54. Therefore, when turned rightward, the motorcycle head 2 can be prevented from swinging by means of the oil pressure resistance inside the swing preventer 5. Thus, under the condition of not changing the structure of the originally designed swing preventer 5, the swing stroke of the swing preventer 5 can be shortened by using the connecting member 3 to extend the swing preventer 5 to a location close to the steering shaft 20. By so designing, a comparatively short swing preventer 5 can be assembled on a motorcycle to enable a rider to steadily control the motorcycle head 2 and keep the motorcycle body steady and smooth for insuring safety in riding.

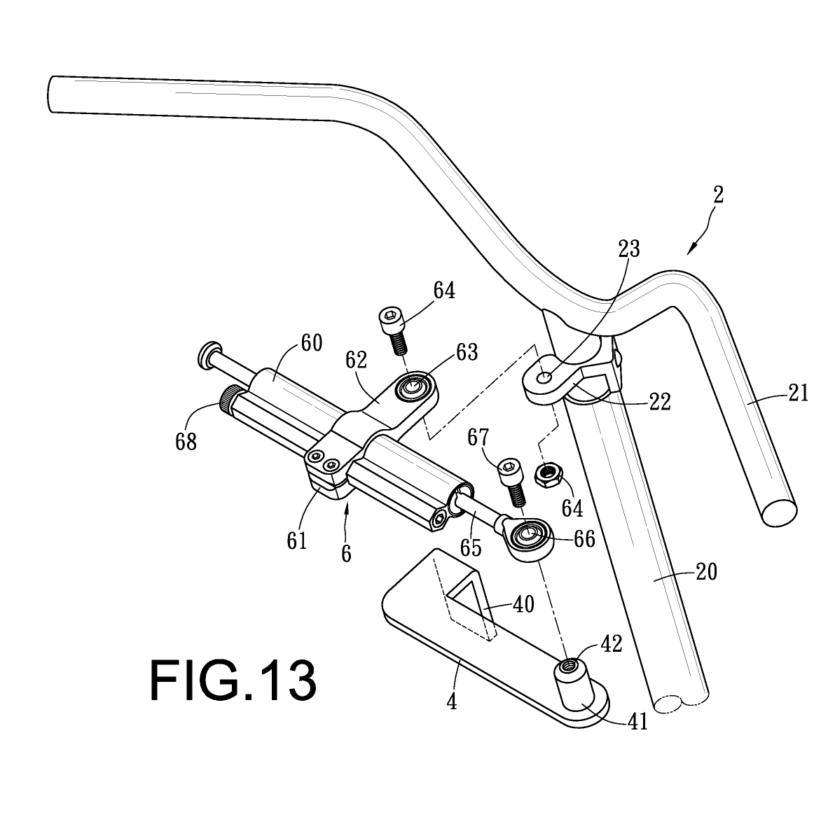

A second preferred embodiment of a motorcycle swing-preventing device in the present invention, as shown in FIGS. 13 to 16, includes a motorcycle head 2 (such as a scooter head), a positioning base 4 and a swing preventer 6 combined together.

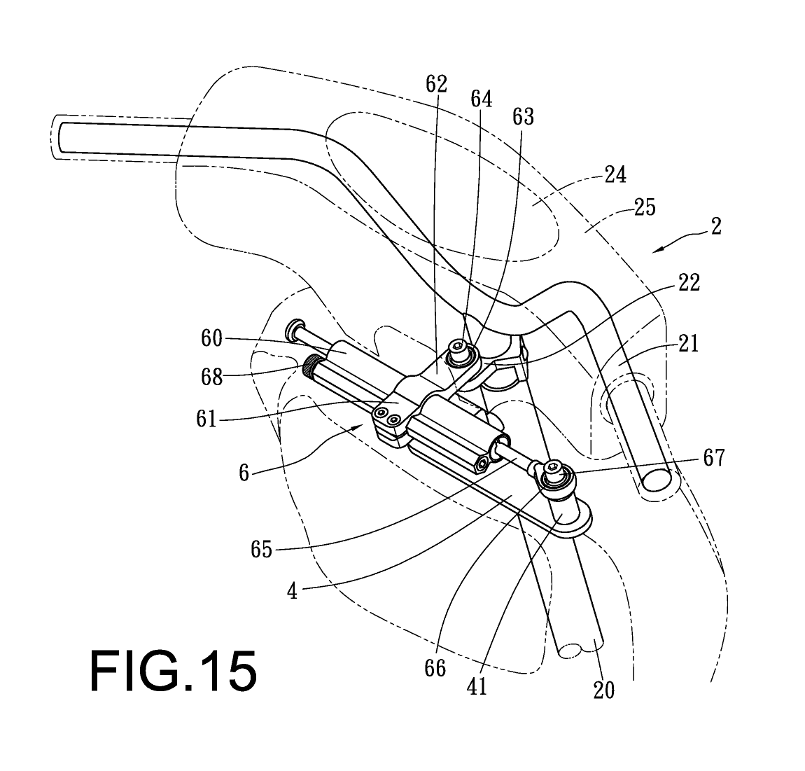

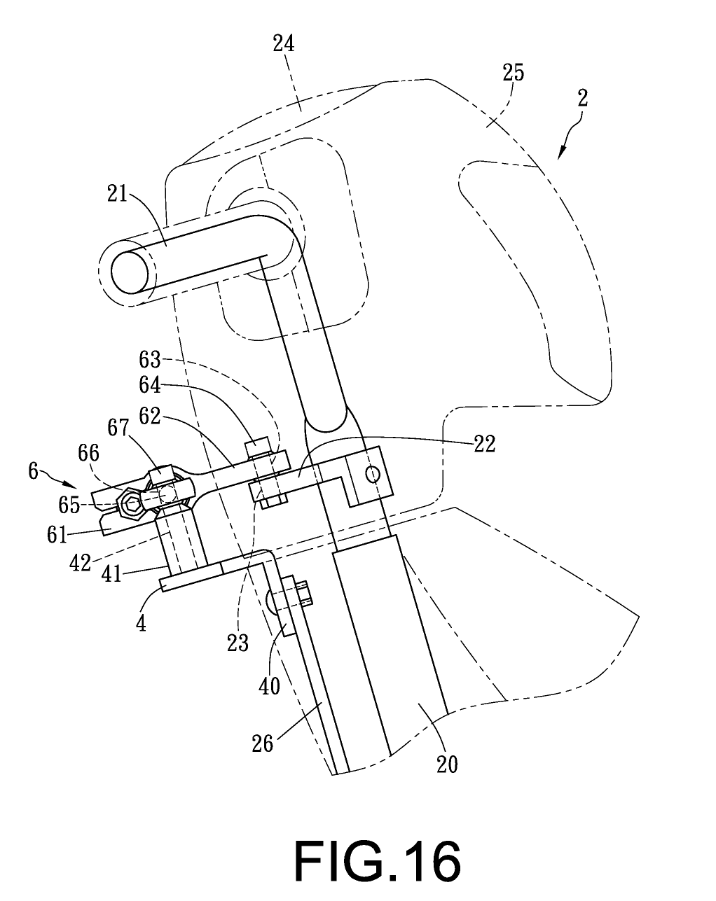

The motorcycle head 2 is provided with a steering shaft 20 having its topside fitted with a handgrip 21 and its upper end secured with a fixing base 22 with an insert hole 23. The motorcycle head 2 has its upper side disposed with an instrument panel 24, as shown in FIG. 15, and its outer side covered with a shell 25 having a motorcycle frame 26 positioned therein, as shown in FIG. 16.

The positioning base 4 to be secured on the frame 26 has one end bent vertically and formed with a positioning plate 40 and the other end fixed thereon with a stud 41 with a threaded hole 42.

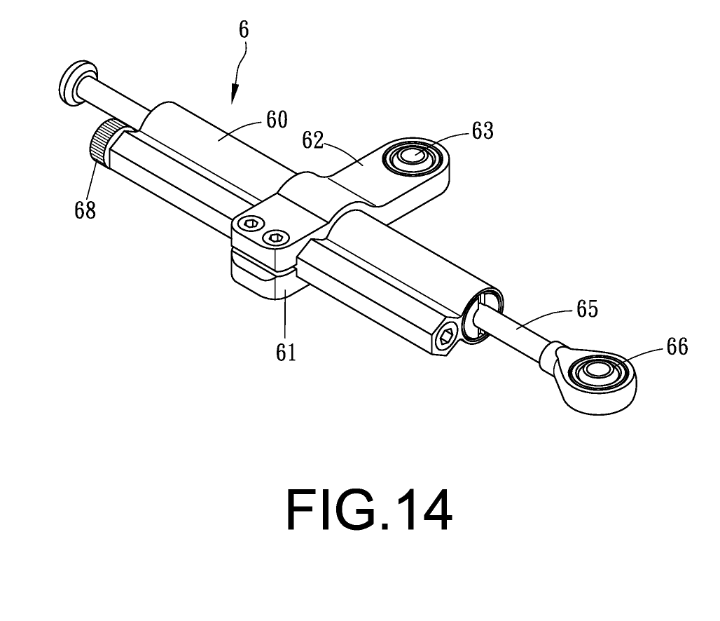

The swing preventer 6, as shown in FIG. 14, is pivotally combined with the fixing base 22 and the positioning base 4, provided with a casing 60 having its intermediate exterior secured with a fixing base 61 having one side extending outward for a proper length and formed with a connecting base 62. The connecting base 62 is fitted thereon with a universal bearing 63 inserted therein with a pivot member 64. A damping rod 65 is inserted in the interior of the casing 60 of the swing preventer 6, having one end provided with a universal bearing 66 inserted therein with a pivot member 67. The casing 60 of the swing preventer 6 is further disposed with a pressure-regulating button 68.

In assembling, as shown in FIGS. 13 to 16, firstly, the positioning plate 40 of the positioning base 4 is fixed on the frame 26, and the universal bearing 63 of the connecting base 62 of the swing preventer 6 is aligned to the insert hole 23 of the fixing base 22 of the steering shaft 20, and then the pivot member 64 is inserted through both the universal bearing 63 and the insert hole 23 of the fixing base 22 for pivotally positioning the swing preventer 6 on the fixing base 22. Next, the universal bearing 66 at one end of the damping rod 65 is aligned to the stud 41 of the positioning base 4, and the pivot member 67 is inserted through the universal bearing 66 and screwed with the threaded hole 42 of the stud 41 for pivotally fixing one end of the damping rod 65 on the positioning base 4, and the swing preventer 6 is positioned at the outer side of the motorcycle shell 25 for facilitating the rider to regulate the pressure-regulating button 68 for controlling the oil pressure resistance inside the swing preventer 6, thus finishing assembly of a motorcycle swing-preventing device.

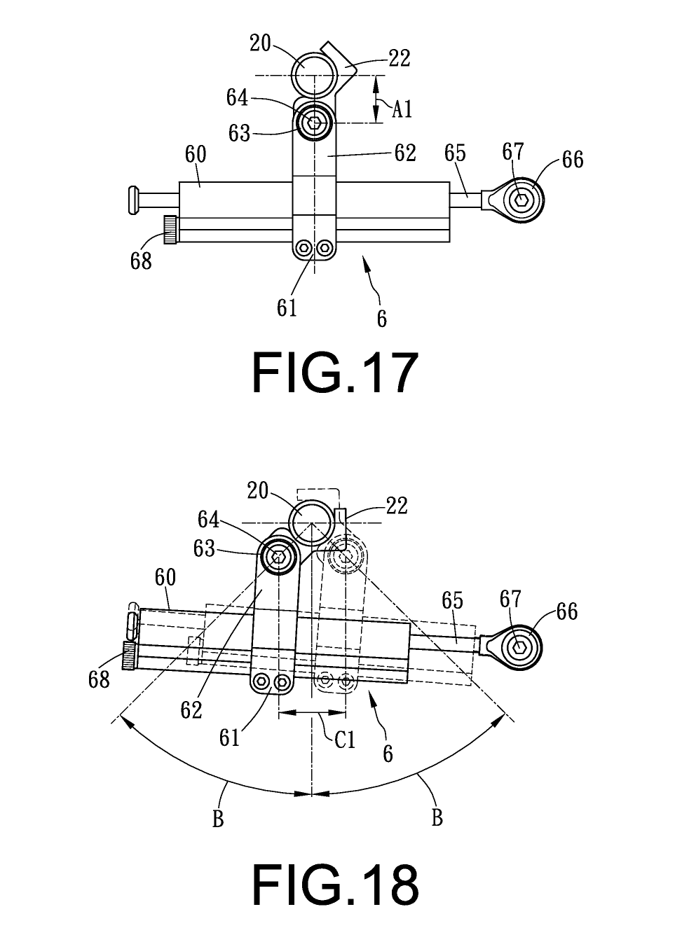

The second preferred embodiment of the motorcycle swing-preventing device in the present invention is to have the connecting base 62 of the swing preventer 6 extending outward to a proper length, as shown in FIGS. 14, 17 and 18, and the universal bearing 63 to be pivotally combined with the steering shaft 20 is positioned at the outer end of the connecting base 62. In addition, the steering shaft 20 is fixed with the fixing base 22 extending outward to be pivotally combined with the connecting base 62 of the swing preventer 6, letting the fulcrum of the swing preventer 6 extend outward for shifting its fulcrum location to the outer end of the connecting base 62. Thus, by changing the location of the fulcrum of the swing preventer 6, the distance (A1) between the fulcrum (the universal bearing 63) of the swing preventer 6 and the steering shaft 20 of the motorcycle head 2 can be shortened, thus shortening the swing stroke (C1) of the swing preventer 6, referring to the stroke (C1) in FIG. 18. The swing preventer 6 with a comparatively small stroke (C1) in the second preferred embodiment of this invention equally can attain a comparatively large steering angle (B), and the stroke (C1) of the swing preventer 6 of this invention is shorter than the stroke (C) of the conventional swing preventer 13 by ⅓ to ½, thus diminishing the size of the swing preventer 6 and having the same effect as that described in the first preferred embodiment.

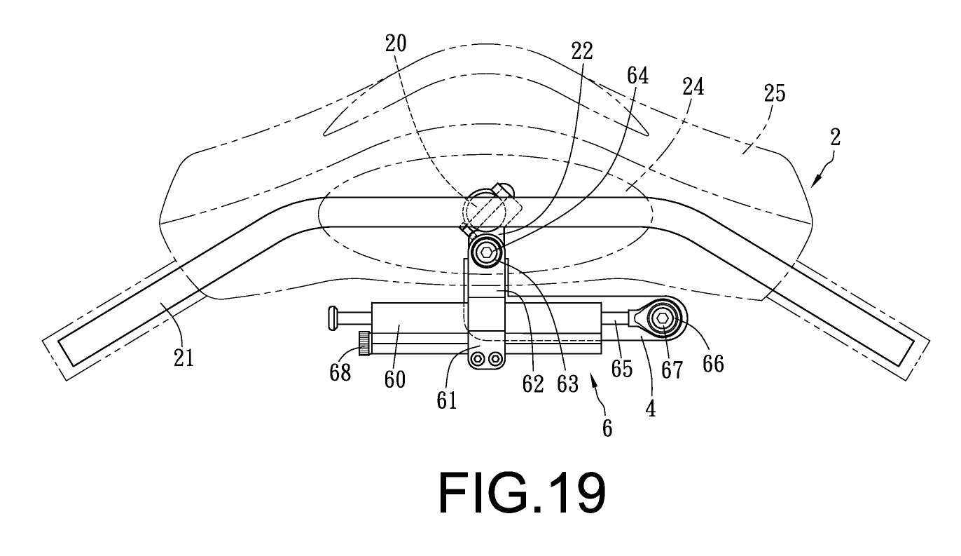

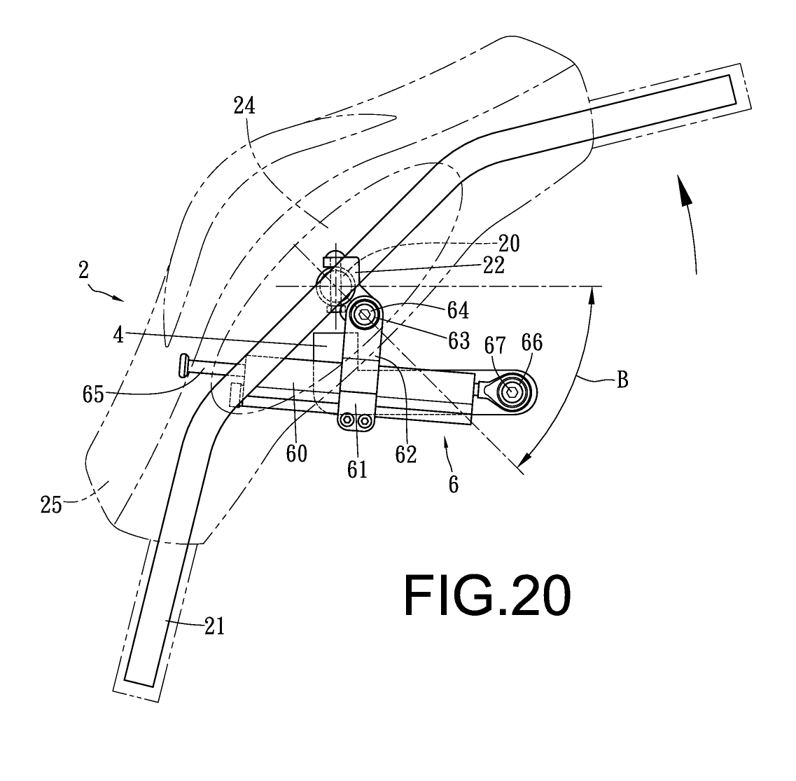

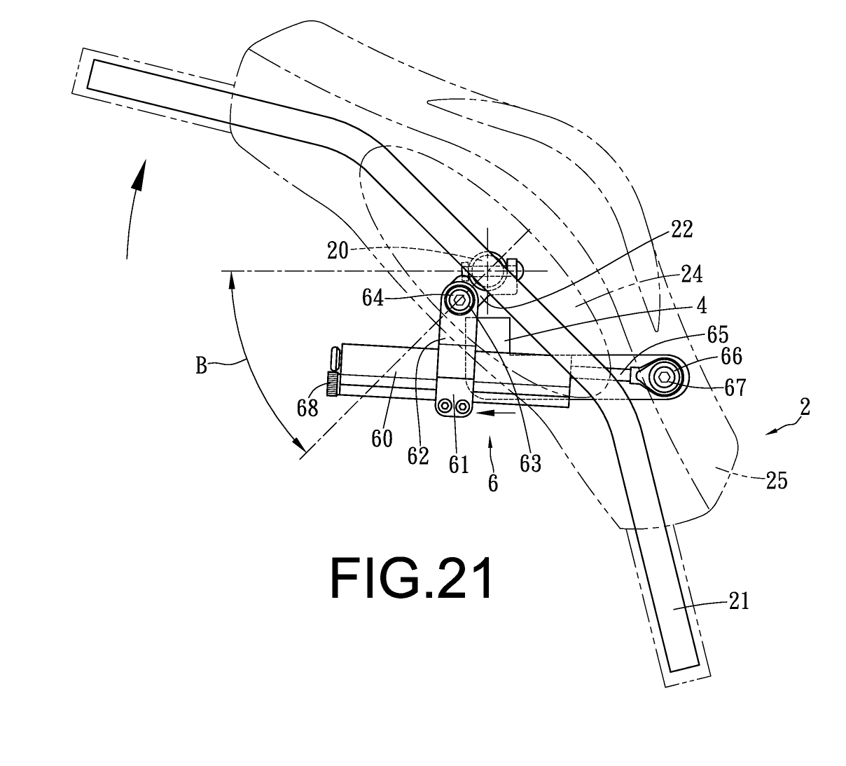

In using, when the handgrip 21 of the motorcycle head 2 is turned leftward, as shown in FIGS. 19 and 20, the steering shaft 20 will drive the fixing base 22 to turn counterclockwise and actuate the connecting base 62 of the swing preventer 6 to move rightward. Since the universal bearing 66 at one end of the damping rod 65 of the swing preventer 6 is pivotally combined with the positioning base 4; therefore, when the fixing base 22 is turned counterclockwise to actuate the connecting base 62 of the swing preventer 6 to shift rightward, the connecting base 62 will actuate the casing 60 of the swing preventer 6 to slide and move rightward along the damping rod 65, but the damping rod 65 will be kept immovable. Thus, when turned leftward, the motorcycle head 2 can be prevented from swinging by means of the oil pressure resistance in the interior of the swing preventer 6. When the handgrip 21 of the motorcycle head 2 is turned rightward, as shown in FIG. 21, the steering shaft 20 will drive the fixing base 22 to turn clockwise and actuate the connecting base 62 of the swing preventer 6 to move leftward, and synchronously the connecting base 62 will actuate the casing 60 of the swing preventer 6 to slide and move leftward along the damping rod 65. Thus, when turned rightward, the motorcycle head can be prevented from swinging by means of the oil pressure resistance inside the swing preventer 6. By so designing, the turning fulcrum of the swing preventer 6 can be extended outward to a location close to the steering shaft 20 for shortening the swing stroke of the swing preventer 6, enabling a rider to control the motorcycle head 2 with steadiness and keep the motorcycle body steady and smooth for insuring riding safety.

While the preferred embodiments of the invention have been described above, it will be recognized and understood that various modifications may be made therein and the appended claims are intended to cover all such modifications that may fall within the spirit and scope of the invention.

What is claimed is:

1. A motorcycle swing-preventing device comprising a motorcycle head provided with a steering shaft, said steering shaft having its topside fitted with a handgrip and its upper end secured with a fixing base, said fixing base bored with an insert hole, a motorcycle frame assembled inside the shell of said motorcycle head;
a connecting member pivotally combined with said fixing base, said connecting member disposed thereon with a universal bearing, said universal bearing inserted therein with a pivot member;
a positioning base secured on said motorcycle frame; and
a swing preventer combined with both said connecting member and said positioning base, said swing preventer provided with a casing, said casing having its outer side secured with a fixing base, said fixing base having one side secured with a connecting base, said connecting base disposed thereon with a universal bearing, said universal bearing of said connecting base secured with said connecting member, a damping rod inserted in the interior of said casing of said swing preventer, said damping rod having one end assembled with a universal bearing, said universal bearing of said damping rod inserted therein with a pivot member, said casing of said swing preventer assembled thereon with a pressure-regulating button.

2. The motorcycle swing-preventing device as claimed in claim 1, wherein said connecting member has one side cut with an insert recess and its topside bored with an insert hole communicating with said insert recess, a fastener inserted through said insert hole for firmly fixing said universal bearing of said connecting base of said swing preventer.

3. The motorcycle swing-preventing device comprising a motorcycle head provided with a steering shaft, said steering shaft having its topside mounted with a handgrip, said steering shaft having its upper end secured with a fixing base with an insert hole, a motorcycle frame installed inside the shell of said motorcycle head;
a positioning base fixed on said motorcycle head; and
a swing preventer pivotally combined with both said fixing base of said steering shaft and said positioning base, said swing preventer disposed with a casing, said casing having its outer side secured with a fixing base, said fixing base having one side extending outward for a proper length and formed with a connecting base, said connecting base fitted thereon with a universal bearing, said universal bearing of said connecting base inserted therein with a pivot member, a damping rod inserted in said casing of said swing preventer, said damping rod having one end disposed with a universal bearing, said universal bearing of said damping rod inserted therein with a pivot member, said casing of said swing preventer provided thereon with a pressure-regulating button.

4. The motorcycle swing-preventing device as claimed in claim 1, wherein said positioning base is provided with a positioning plate to be secured on said motorcycle frame and fixed with a stud with a threaded hole to be pivotally combined with said damping rod of said swing preventer.

5. The motorcycle swing-preventing device as claimed in claim 3, wherein said positioning base is provided with a positioning plate to be secured on said motorcycle frame and fixed with a stud with a threaded hole to be pivotally combined with said damping rod of said swing preventer.
